(19) United States
(12) Patent Application Publication
(10) Pub. No.: US 2012/0331517 A1
(43) Pub. Date: Dec. 27, 2012

(54) METHOD AND SYSTEM FOR FILTERING OBSCENE CONTENT FROM ELECTRONIC BOOKS AND TEXTUALIZED MEDIA

(76) Inventor: Wesley Wilcox, South Weber, UT (US)

(21) Appl. No.: 13/167,241

(22) Filed: Jun. 23, 2011

(51) Int. Cl. G06F 17/21; G06F 21/00

(52) U.S. Cl. 726/1; 715/256

(57) ABSTRACT

A method and system is disclosed for filtering obscene content from digital media comprising textualized script, such as electronic books commonly read on iPads®, Kindles®, and the like. Obscene content, in some embodiments, is redacted from the textualized media. In other embodiments, the obscene content is substituted with less obscene content. In still further embodiments, obscene content is flagged and a reader or administrator prompted to instruct the system how to handle the obscene content.

### BACKGROUND OF THE INVENTION

1. Field of the Invention

This invention relates to content filtering, and more particularly relates to a method, system and computer program product for filtering obscene content from textualized digital media.

2. Description of the Related Art

Vendors of electronic books and textualized digital media, such as electronic books are gaining market share relative to publishers of printed media, due in part to the proliferation of compact devices for conveniently reading electronic media, such as iPads®, Kindles®, and the like. Google is in the process of digitizing, and textualizing, all printed books available, and soon the demand for textualized digital media, read from electronic devices, will predominate the old market for published literature.

With the increasing demand for digital media, comes increasing concerns on the part of parents, guardians, schools, employers, and other organizations that minors under their guardianship may be exposed to profanity, depravity, obscenities, and/or descriptions of sexuality, violence and the like within the text.

Although methods exist in the art of filtering obscene content from video and other multimedia, the art does not teach any effective methods of filtering, flagging, redacting, or replacing obscene content in textualized media.

The present invention aims to remedy this problem.

### SUMMARY OF THE INVENTION

From the foregoing discussion, it should be apparent that a need exists for a method, system and computer program product for more efficiently filtering obscene content from textualized media. The present invention has been developed in response to the present state of the art; and, in particular, in response to the problems and needs in the art that have not yet been fully solved by currently available methods, systems and apparatii, and that overcome many or all of the above-discussed shortcomings in the art. Accordingly, the present invention has been developed to provide a method and system for filtering obscene content from textualized digital media.

A method is disclosed for deconstructing an obscene textualized digital file to create a non-obscene digital file, the steps of the method comprising: receiving a textualized digital source file; storing the source file in computer readable memory; parsing the source file by: scanning one or more paragraphs in the file for one or more words listed in a first match list; modifying the source file to create a modified file by deleting words in the source file which are listed in the first match list; and adding metadata to the file comprising data indicative of a level of modification to which the source file was subjected.

The method may further comprising displaying the modified file on a computer display. The method may also further comprising modifying the source file by replacing words in the source file, which words are listed in the first match list, with corresponding replacement words listed a first replacement list, each replacement word in the replacement list exclusively associated with a word in the first match list.

In some embodiments, the method further comprises parsing the source file by scanning one or more paragraphs in the file for one or more phrases listed in a second match list; and modifying the source file to create a modified file by replacing phrases in the source file which are listed in the second match list.

In other embodiments, the method further comprises: counting the words in the source file listed in the match list; generating a rating indicative of the level of obscenity in the source file, the rating a function of the number of counted words; and appending the rating to the modified file in computer readable memory.

The method may also comprise assigning a multiplier value to each word in the first match list; counting the words in the source file listed in the match list; generating a rating indicative of the level of obscenity in the source file, the rating a function of the number of counted words and the multiplier value of each counted word; and appending the rating to the modified file in computer readable memory.

A second method of deconstructing an obscene textualized digital file to create a non-obscene digital file is disclosed, the steps of the method comprising: receiving a textualized digital source file; storing the source file in computer readable memory; prompting a human authority figure to select a security level from a plurality of security levels, each security level associated with a match list comprising a plurality of phrases, the phrases comprising one or more word(s); parsing the source file by: scanning one or more paragraphs in the file for one or more words listed in a first match list; in response to the authority figure selecting a first security level, modifying the source file to create a modified file by deleting words in the source file which are listed in the first match list; in response to the authority figure selecting a second security level, modifying the source file to create a modified file by replacing words in the source file with words which are listed in the second match list; in response to the authority figure selecting a third security level, modifying the source file to create a modified file by flagging words on the first match list in the source file with marcation distinguishing them from other words; and adding metadata to the file comprising data indicative of the security level selected by the authority figure.

A third method of deconstructing an obscene textualized digital file to create a non-obscene digital file is disclosed, the steps of the method comprising: receiving a textualized digital source file; storing the source file in computer readable memory; parsing the source file by: finding one or more phrases in the file matching one or more phrases listed in a first match list, the phrases comprising one or more word(s); in response to finding one more words, modifying the source file by deleting all sentences comprising any of the found phrases; and adding metadata to the file comprising data indicative of the existence of the modified file.

The method may further comprise: in response to finding one more phrases, modifying the source file by deleting all paragraphs comprising any of the found phrases. The method may additionally comprise replacing deleted sentences in the modified file with a string of text indicating that text was deleted.

The method may further comprise: prompting an authority figure to select a filtering level. The method may further comprise, in response to an authority figure selecting a first security level, modifying the source file to create a modified file by replacing words in the source file with words which are listed in the second match list.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an entity-relationship diagram of the interacting entities of a system in accordance with the present invention;

FIG. 2 is a block diagram illustrating the data interconnectivity in a computer readable data structure comprising textualized digital media;

FIG. 3 is a block diagram illustrating the relative size of operations inherent in security levels in accordance with a method of the present invention;

FIG. 4 is a data flow chart illustrating the flow of data in and out of an obscene textualized digital file in accordance with a method of the present invention;

FIG. 5 is a flowchart illustrating steps of a method for deconstructing an obscene textualized digital file to create a non-obscene digital file in accordance with the present invention; and

FIG. 6 is a program flowchart illustrating steps of a method for deconstructing an obscene textualized digital file to create a non-obscene digital file in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

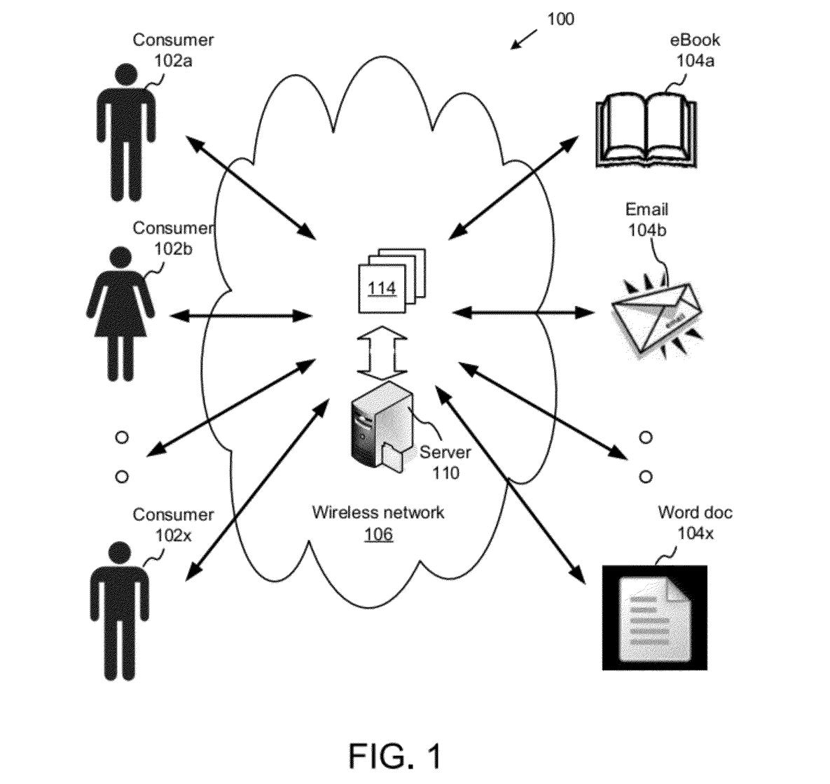

FIG. 1 is an entity-relationship diagram of the interacting entities of a system 100 in accordance with the present invention. The entities in the system 100 comprise consumers 102a-x, textualized files 104a-x, a wireless network 106, and a server 110, and computer readable storage 114.

The server 110, in some embodiments, may comprise a computer program running on one or more data processing devices (DPDs), such as a server, computer workstation, router, mainframe computer, cellular smart phone, or the like. In various embodiments, the DPD comprises one or more processors. The processor is a computing device well-known to those in the art and may include an application-specific integrated circuit (“ASIC”).

The server 110 comprises the front end logic necessary to receive and transmit bitstreams (i.e., datastreams). The server 110 may include the software, firmware, and hardware necessary to receive and process textualized content, including buffers, data unloaders, video unloaders, and the like.

The server 110 may be functionally capable of demultiplexing the content units of multimedia, such as MPEG compliant content units.

In various embodiments, the server 110 may be in direct communication with DPDs of consumers 102, such as cellular phones, iPads, Kindles, and he like.

The server 110 is configured, in certain embodiments, to scan and modify the text in textualized files 104. The server 110 may create a textualized digital file comprising, or substantially comprising, portions of a source textualized file 104. This recreated file is the modified file, or modified textualized digital file.

In some embodiments, the modified textualized digital file is stored in nonvolatile computer readable memory, while the received file 104 is stored in volatile computer readable memory.

In the shown embodiment, the textualized digital files 104 and modified files are stored computer readable memory under the control of a DBMS or RDBMS like the database server 101.

The server 110 is configured to identify and store in volatile or nonvolatile memory portions of the textualized digital files containing words or phrases identified as pornographic, profane, obscene, or otherwise objectionable.

The consumers 102a-x may comprise any person, company or organization that is potentially a reader or receiver of digital media, including children living with their parents. The consumers 102a-x may interact in the free market, where they may purchase electronically published books.

The textualized files 104a-x comprises any computer readable files with computer identifiable text, including formats: Word, PDF, and the like.

In the shown embodiment, merchants, contacts, acquaintances, and/or third-parties send textualized digital files to consumers 102 using the server 110, which server 110 interconnects consumers 102 via the network 106 to those entities forwarding the textualized files 104a-x.

The consumers 102a-x, in various embodiments, receive the textualized digital files electronically via means known to those of skill in the art, including using variations of the Simple Mail Transfer Protocol (SMTP), Internet Message Access Protocol (IMAP), Post Office Protocol (POP), or other protocols well-known to those of skill in the art.

The wireless network 106 may comprise the Internet or any set of DPD communicating through a networked environment, such as local area network (LAN) or wide area network (WAN).

It is an object of the present invention to remove objectionable and/or obscene content from the textualized files 104, as further described below. In some embodiments, the obscene content is removed or replaced and a new file containing the modifications is created.

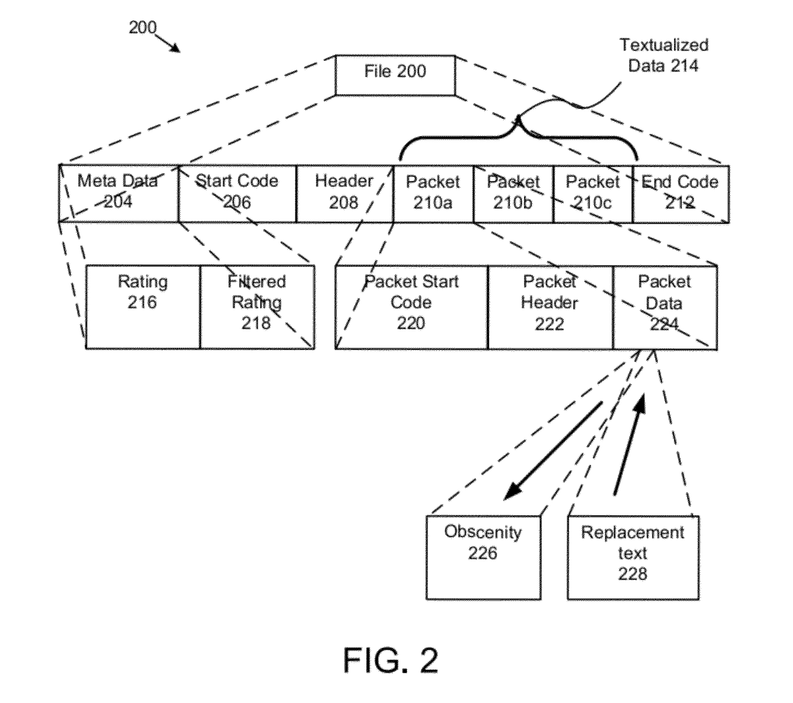

FIG. 2 is a block diagram illustrating the data interconnectivity in a computer readable data structure 200 comprising textualized digital media. The data structure 200 comprises metadata 202, a start code 204, a header 208, content packets 210a-c, and an end code 212. The metadata 202 comprises a rating 216 and a filtered rating 218. The packet 210a comprises a packet start code 220, a packet header 222, and packet data 224. The packet data 224 may comprise an obscenity 226 and/or replacement text 228.

The data structure 200 contains packets linked together by standard tables built when the modified file 200 was created.

The text shown to readers of the textualized media is contained in the content packets 210a-c. This textualized information in the packets 210a-c is searchable by the server 110 for objectionable content. The server 110 may search this data for obscene content before it is processed into the modified textualized digital file 200, or the server 110 may extract obscene contention from the content packets 210a-c after receiving the search request from a reader, administrator, or software program running on the server 110 or other components in a system.

In various embodiments, the DBMS or RDBMS managing the textualized digital files reduces the search request to a query execution plan using hash tables and the like.

These database queries may be generated using various languages including SQL, XPATH, and the like. Keywords may also comprise other identifiers relevant to creating, or identifying, the proper query execution plan.

The database queries may be dynamic (meaning the query is generated as needed by a user with a form that is unknown until the query is received by the database server 110 and which form is likely to change between requests) or static (meaning the database query is predefined does not change form between requests, although the parametric data values of the query may change).

The server 110 may receive a user selected filter level before or after receiving the textualized source file. The modified file may be displayed, broadcast and/or viewed after construction in any number of formats known to those of skill in the art, including Word, PDF, and the like.

In some embodiments, digital books that have been filtered are saved for future reference. In those embodiments, changes previously made to an earlier version of a literary work may be stored in computer readable memory for reference if the identical work is again presented for content filtering. In various embodiments, the modified file 200 of a literary work is saved for reference, while in other embodiments, a log file is stored in a database in computer readable memory which stores sequentially the changes made to original, unmodified text of the literary work.

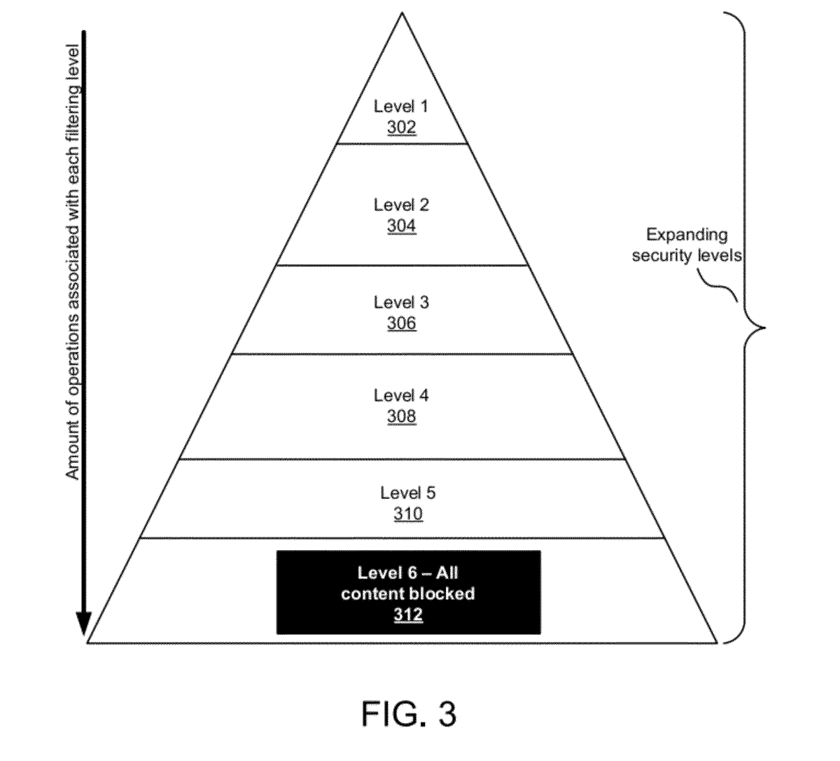

FIG. 3 is a block diagram illustrating the relative size of operations inherent in security levels in accordance with a method of the present invention.

If a user selects, for instance, a filtering level of one (level one 302), the filtering operations to which an original, unmodified text is subjected are much lower (as represented by level one 302 in FIG. 3) than the operations to which the textualized data is subjected in level two 304.

With each increase in the security level, or content filtering level, selected by a user, additional operations are performed on the textualized data. In the highest level of filtering, level six 312, a text may be rejected in its entirely because of objectionable content that is identified by scripts. In these embodiments, a child or reader attempting to view the modified text file 200 would be unable to view any portion of the file.

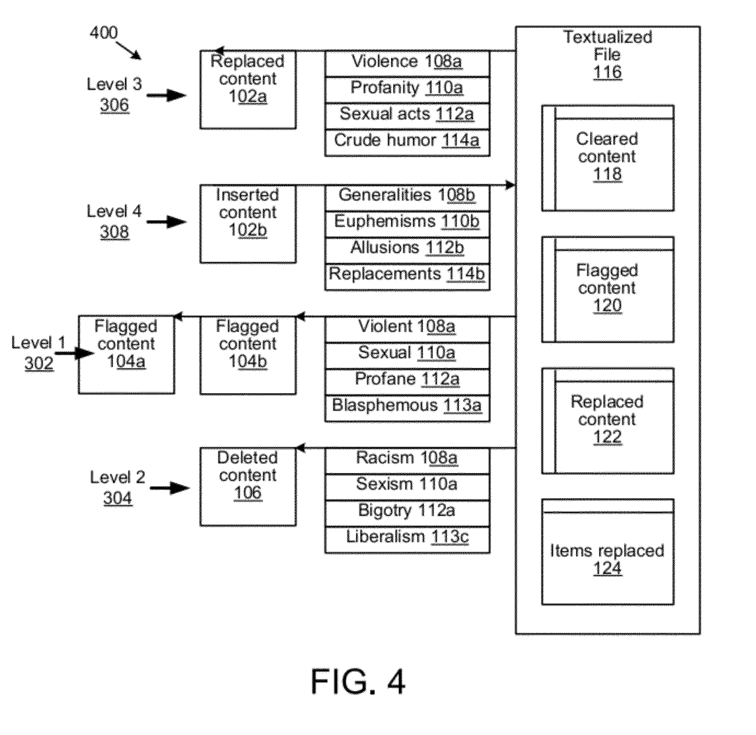

FIG. 4 is a data flow chart illustrating the flow of data in and out of an obscene textualized digital file 400 in accordance with a method of the present invention.

The textualized file 116 comprises a database file comprising unfiltered literary work in textualized digital form. After being subjected to content filtering in accordance with the present invention, the database file comprises several records, including cleared content 118, flagged content 120, replaced content 122, and a log file of items replaced 124.

When the unfiltered text file 116 is subjected to level three 306 filtering, obscenities, such as “shit,” “hell,” and “damn,” are replaced respectively by corresponding words in a digital match list, such as “crap,” “heck,” and “darn,” which words are meant to connote less offensive meaning.

Additionally, in level three 306 filtering, violent words such a “rape” and “torture” may be replaced with less offensive words, such as “violate” and the like. Additionally, passages containing crude humor, including humor with incorporating sexually explicit terms or terms denoting bodily wastes are replaced with corresponding words or phrases in a second match list.

In level four 308 filtering, offensive words and/or phrases in the unmodified literary work identified by referencing a first match list are replaced by generalities or euphemisms which do not denote or connote the same meaning as the original words and/or phrases. For instance, a passage like “beat the shit out of her,” would be replaced with a passage simply saying, “cause her harm,” or “make her uncomfortable.”

In level one 302 filtering, objectionable content is neither replaced or deleted, but rather flagged for review by a third-party reader. Content which may be flagged includes violent content, sexual content, profane content, or even blasphemous content. Blasphemous content may be removed if, for instance, required by guidelines of a religious institution before dissemination. Each of these types of content are identified in the unmodified text by scanning the text for one or more words and/phrases, and/or combinations or words or phrases.

Upon independent third-party review, flagged content may be selectively replaced, deleted, ignored or modified.

Likewise, in level two 304, objectionable content, including racism 108a, sexism 110a, bigotry 112a, and liberalism 113c, may be simply deleted from the unmodified digital text. In these embodiments, either the objectionable content alone may be deleted, or corresponding passages of text deleted with it, such as the sentence or paragraph containing the objectionable text.

In each level of filtering, a log file 124 is written into the file 116 showing all changes made to the unmodified text. Content that is replaced is written into a database record 122, and content that is flagged in written into a separate database record 120, while content that has passed the content filtering operations is stored in a database file 118.

In various embodiments, words identified in the first match list include profane words such as: hell, damn, fuck, shit, ass, bastard, and the like. Words or phrases with racist and/or sexist and/or homophobic connotations or denotations may also be identified in the first or second match list, and include: nigger, negroe, cracker, bitch, wetback, fag, faggot, slant eye, jap, and the like.

Lesser objectionable words may include: stupid, moron, idiot, which may be deleted or replaced in higher levels of content filtering, while sexual words and/or phrases may be categorized, including “son of a bitch,” “oral sex,” “blow job,” “blanket party,” “bachelor party,” and the like.

Even political content may be flagged as objectionable in accordance with the present invention, and identified by parsing the source file 104 for words or phrases with political content, such as: liberal, hippie, racist, conservative, hate monger, illegal immigrant, votes, and the like.

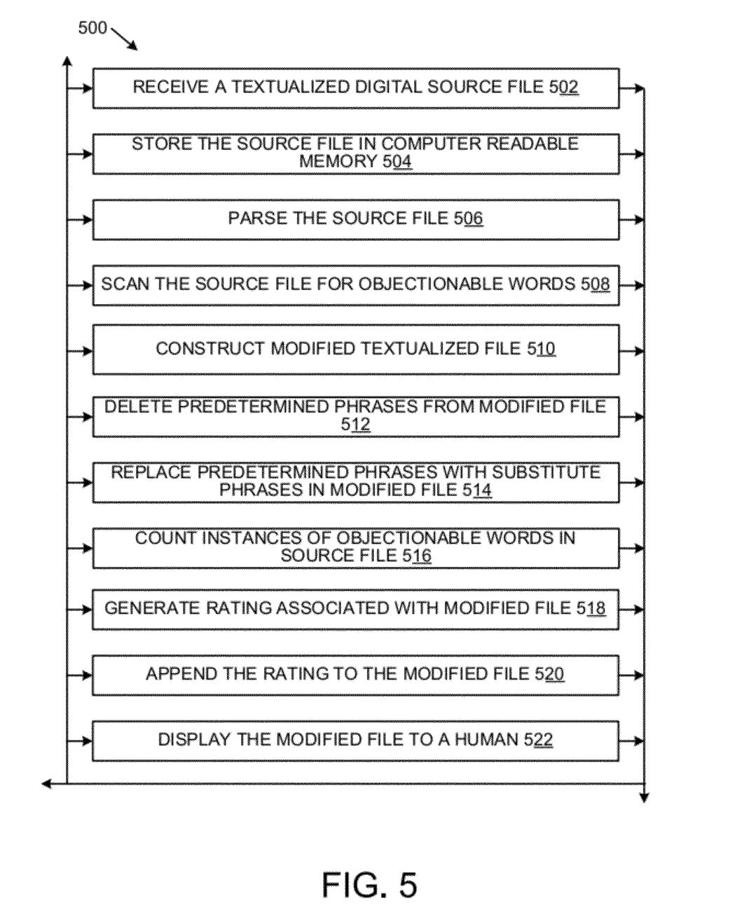

FIG. 5 is a flowchart illustrating steps of a method 500 for deconstructing an obscene textualized digital file to create a non-obscene digital file in accordance with the present invention.

In accordance with the steps of method 500, a textualized digital source file is received 502. This file may be uploaded to the server 110 or downloaded to a Kindle, iPad or the like by a user. The source file is stored 504 in computer readable memory, and parsed 506 if necessary into blocks of text for analysis and content filtering.

The source file is scanned 508 for objectionable content, and a modified file 200 is constructed 510 from the original file 116. Words and/or phrases in the original file which are matched in a first match file are deleted 512 in some embodiments, while other words showing in a second or third match file are replaced 514 with substitute words and/or phrases.

In various embodiments, the number of times that objectionable content is identified in the original file 116 are totaled, and this total is used in determining 518 a rating for the original file, which approximately identifies the relative nature of the obscene content in the original work for subsequent readers of the modified file 200.

This rating is appended 520 to the file 200 for display 522 to human readers.

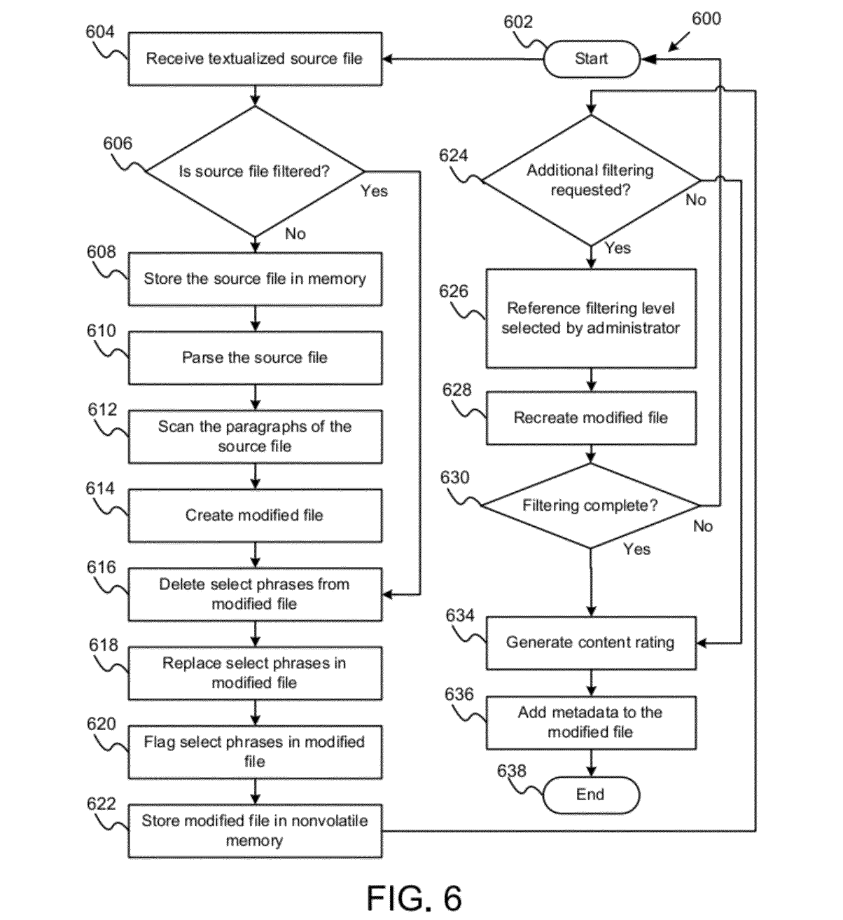

FIG. 6 is a program flowchart illustrating steps of a method 600 for deconstructing an obscene textualized digital file to create a non-obscene digital file in accordance with the present invention.

In accordance with method 600, a source file is received 602. The source file referenced to see if it has already been subjected to content filtering 606. If it has not, the source file is stored 608 in computer readable memory, then subjected to the steps of method 500.

After being subjected to method 500, a user is asked to view the file 200 and respond to a request for additional filtering. If additional filtering is requested 624, then the filtering level requested by the user is referenced 626, and new modified file 200 is created 628. If the filtering is complete 630, a content rating is generated 634 using the number of times that objectionable content in the original filing was found as a parameter in the rating generation. Finally, metadata comprising the log file 124 and database files 120 and 122 are appended to the modified file 200, and the method 600 terminates 638.

In various embodiments of the present invention, the modified file 200 and/or the unmodified file 116 are additionally subjected to encryption such that children and/or employees and the like cannot access the file(s) with permission granted in the form of the password from an administrator.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of deconstructing an obscene textualized digital file to create a non-obscene digital file, the steps of the method comprising:
receiving a textualized digital source file;
storing the source file in computer readable memory;
parsing the source file by:
scanning one or more paragraphs in the file for one or more words listed in a first match list;
modifying the source file to create a modified file by deleting words in the source file which are listed in the first match list; and
adding metadata to the file comprising data indicative of a level of modification to which the source file was subjected.

2. The method of claim 1, further comprising displaying the modified file on a computer display.

3. The method of claim 1, further comprising modifying the source file by replacing words in the source file, which words are listed in the first match list, with corresponding replacement words listed a first replacement list, each replacement word in the replacement list exclusively associated with a word in the first match list.

4. The method of claim 1, further comprising:
parsing the source file by scanning one or more paragraphs in the file for one or more phrases listed in a second match list; and
modifying the source file to create a modified file by replacing phrases in the source file which are listed in the second match list.

5. The method of claim 1, further comprising:
counting the words in the source file listed in the match list;
generating a rating indicative of the level of obscenity in the source file, the rating a function of the number of counted words; and
appending the rating to the modified file in computer readable memory.

6. The method of claim 1, further comprising:
assigning a multiplier value to each word in the first match list;
counting the words in the source file listed in the match list;
generating a rating indicative of the level of obscenity in the source file, the rating a function of the number of counted words and the multiplier value of each counted word; and
appending the rating to the modified file in computer readable memory.

7. A method of deconstructing an obscene textualized digital file to create a non-obscene digital file, the steps of the method comprising:
receiving a textualized digital source file;
storing the source file in computer readable memory;
prompting a human authority figure to select a security level from a plurality of security levels, each security level associated with a match list comprising a plurality of phrases, the phrases comprising one or more word(s);
parsing the source file by:
scanning one or more paragraphs in the file for one or more words listed in a first match list;
in response to the authority figure selecting a first security level, modifying the source file to create a modified file by deleting words in the source file which are listed in the first match list;
in response to the authority figure selecting a second security level, modifying the source file to create a modified file by replacing words in the source file with words which are listed in the second match list;
in response to the authority figure selecting a third security level, modifying the source file to create a modified file by flagging words on the first match list in the source file with marcation distinguishing them from other words; and
adding metadata to the file comprising data indicative of the security level selected by the authority figure.

8. A method of deconstructing an obscene textualized digital file to create a non-obscene digital file, the steps of the method comprising:
receiving a textualized digital source file;
storing the source file in computer readable memory;
parsing the source file by:
finding one or more phrases in the file matching one or more phrases listed in a first match list, the phrases comprising one or more word(s);
in response to finding one more words, modifying the source file by deleting all sentences comprising any of the found phrases; and
adding metadata to the file comprising data indicative of the existence of the modified file.

9. The method of claim 8, further comprising: in response to finding one more phrases, modifying the source file by deleting all paragraphs comprising any of the found phrases.

10. The method of claim 8, further comprising replacing deleted sentences in the modified file with a string of text indicating that text was deleted.

11. The method of claim 8, further comprising: prompting an authority figure to select a filtering level.

12. The method of claim 8, further comprising: in response to an authority figure selecting a first security level, modifying the source file to create a modified file by replacing words in the source file with words which are listed in the second match list.
